(19) United States
(12) Patent Application Publication
(10) Pub. No.: US 2016/0234456 A1
(43) Pub. Date: Aug. 11, 2016

(54) DATA PROCESSING APPARATUS FOR TRANSMITTING/RECEIVING COMPRESSED PIXEL DATA GROUPS VIA MULTIPLE CAMERA PORTS OF CAMERA INTERFACE AND RELATED DATA PROCESSING METHOD

(71) Applicant: MEDIATEK INC., Hsin-Chu, Taiwan (CN)

(72) Inventors: Chi-Cheng Ju, Hsinchu City (TW); Tsu-Ming Liu, Hsinchu City (TW)

(21) Appl. No.: 15/024,844

(22) PCT Filed: Oct. 15, 2014
(86) PCT No.: PCT/CN2014/088651

§ 371 Date: Mar. 24, 2016

Related U.S. Application Data
(60) Provisional application No. 61/892,227, filed on Oct. 17, 2013.

(51) Int. Cl. H04N 5/63; H04N 7/01; H04N 19/426; H04N 5/44; H04N 19/85

(52) U.S. Cl. CPC H04N 5/63; H04N 5/44; H04N 19/85; H04N 19/426; H04N 7/01

(57) ABSTRACT

A data processing apparatus includes a compression circuit, a rate controller, and an output interface. The compression circuit generates compressed pixel data groups, each derived from applying a compression operation to pixel data of a pixel group, wherein the pixel group includes a portion of a plurality of pixels in a picture. The rate controller applies bit rate control to each compression operation, wherein the rate controller adjusts the bit rate control according to a position of each pixel boundary between different pixel groups. The output interface outputs the compressed pixel data groups via a plurality of camera ports of a camera interface, respectively.

### CROSS REFERENCE TO RELATED APPLICATIONS

This application claims the benefit of U.S. provisional application No. 61/892,227, filed on Oct. 17, 2013 and incorporated herein by reference.

### FIELD OF THE INVENTION

The disclosed embodiments of the present invention relate to transmitting and receiving data over a camera interface, and more particularly, to a data processing apparatus for transmitting/receiving compressed pixel data groups of a picture via multiple camera ports of a camera interface and a related data processing method.

### BACKGROUND AND RELATED ART

A camera interface is disposed between a first chip and a second chip to transmit multimedia data from the first chip to the second chip for further processing. For example, the first chip may include a camera module, and the second chip may include an image signal processor (ISP). The multimedia data may include image data (i.e., a single still image) or video data (i.e., a video sequence composed of successive images). When a camera sensor with a higher resolution is employed in the camera module, the multimedia data transmitted over the camera interface would have a larger data size/data rate, which increases the power consumption of the camera interface inevitably. If the camera module and the ISP are both located at a portable device (e.g., a smartphone) powered by a battery device, the battery life is shortened due to the increased power consumption of the camera interface. Thus, there is a need for an innovative design which can effectively reduce the power consumption of the camera interface.

### BRIEF SUMMARY OF THE INVENTION

In accordance with exemplary embodiments of the present invention, a data processing apparatus for transmitting/receiving compressed pixel data groups of a picture via multiple camera ports of a camera interface and a related data processing method are proposed.

According to a first aspect of the present invention, an exemplary data processing apparatus is disclosed. The exemplary data processing apparatus includes a compression circuit, a rate controller, and an output interface. The compression circuit is configured to generate a plurality of compressed pixel data groups, each derived from applying a compression operation to pixel data of a pixel group, wherein the pixel group includes a portion of a plurality of pixels in a picture. The rate controller is configured to apply bit rate control to each compression operation, wherein the rate controller adjusts the bit rate control according to a position of each pixel boundary between different pixel groups. The output interface is configured to output the compressed pixel data groups via a plurality of camera ports of a camera interface, respectively.

According to a second aspect of the present invention, an exemplary data processing apparatus is disclosed. The exemplary data processing apparatus includes a compression circuit and an output interface. The compression circuit is configured to generate a plurality of compressed pixel data groups, each derived from applying a compression operation to pixel data of a pixel group according to a compression order, wherein the pixel group includes a portion of a plurality of pixels in a picture, and the compression order is set according to a position of a pixel boundary between the pixel group and an adjacent pixel group. The output interface is configured to output the compressed pixel data groups via a plurality of camera ports of a camera interface, respectively.

According to a third aspect of the present invention, an exemplary data processing apparatus is disclosed. The exemplary data processing apparatus includes a compression circuit and an output interface. The compression circuit is configured to generate a plurality of compressed pixel data groups, each derived from applying a compression operation to pixel data of a pixel group, wherein the pixel group includes a portion of a plurality of pixels in a picture, and at least two pixel groups have overlapped pixels. The output interface is configured to output the compressed pixel data groups via a plurality of camera ports of a camera interface, respectively.

According to a fourth aspect of the present invention, an exemplary data processing apparatus is disclosed. The exemplary data processing apparatus includes an input interface and a de-compressor. The input interface is configured to receive an input bitstream from a camera port of a camera interface, and un-pack the input bitstream into a compressed pixel data group that corresponds to pixels in a partial image area of a picture. The de-compressor is configured to de-compress the compressed pixel data group to generate a de-compressed pixel data group, and discard a portion of the de-compressed pixel data group that corresponds to pixels beyond a target image area within the partial image area.

According to a fifth aspect of the present invention, an exemplary data processing system is disclosed. The exemplary data processing system includes a first data processing apparatus, a second data processing apparatus, and a post-processing circuit. The first data processing apparatus includes a first input interface and a first de-compressor. The first input interface is configured to receive a first input bitstream from a first camera port of a camera interface, and un-pack the first input bitstream into a first compressed pixel data group. The first de-compressor is configured to de-compress the first compressed pixel data group to generate a first de-compressed pixel data group. The second data processing apparatus includes a second input interface and a second de-compressor. The second input interface is configured to receive a second input bitstream from a second camera port of the camera interface, and un-pack the second input bitstream into a second compressed pixel data group. The second de-compressor is configured to de-compress the second compressed pixel data group to generate a second de-compressed pixel data group. The post-processing circuit is configured to smooth at least a pixel boundary between the first de-compressed pixel data group and the second de-compressed pixel data group.

According to a sixth aspect of the present invention, an exemplary data processing method is disclosed. The exemplary data processing method includes: applying bit rate control to each compression operation, wherein the bit rate control is adjusted according to a position of each pixel boundary between different pixel groups; generating a plurality of compressed pixel data groups, each derived from applying a compression operation to pixel data of a pixel group, wherein the pixel group includes a portion of a plurality of pixels in a picture; and outputting the compressed pixel data groups via a plurality of camera ports of a camera interface, respectively.

According to a seventh aspect of the present invention, an exemplary data processing method is disclosed. The exemplary data processing method includes: generating a plurality of compressed pixel data groups, each derived from applying a compression operation to pixel data of a pixel group according to a compression order, wherein the pixel group includes a portion of a plurality of pixels in a picture, and the compression order is set according to a position of a pixel boundary between the pixel group and an adjacent pixel group; and outputting the compressed pixel data groups via a plurality of camera ports of a camera interface, respectively.

According to an eighth aspect of the present invention, an exemplary data processing method is disclosed. The exemplary data processing method includes: generating a plurality of compressed pixel data groups, each derived from applying a compression operation to pixel data of a pixel group, wherein the pixel group includes a portion of a plurality of pixels in a picture, and at least two pixel groups have overlapped pixels; and outputting the compressed pixel data groups via a plurality of camera ports of a camera interface, respectively.

According to a ninth aspect of the present invention, an exemplary data processing method is disclosed. The exemplary data processing method includes: receiving an input bitstream from a camera port of a camera interface, and un-packing the input bitstream into a compressed pixel data group that corresponds to pixels in a partial image area of a picture; and de-compressing the compressed pixel data group to generate a de-compressed pixel data group, and discarding a portion of the de-compressed pixel data group that corresponds to pixels beyond a target image area within the partial image area.

According to a tenth aspect of the present invention, an exemplary data processing method is disclosed. The exemplary data processing method includes: receiving a first input bitstream from a first camera port of a camera interface, and un-packing the first input bitstream into a first compressed pixel data group; de-compressing the first compressed pixel data group to generate a first de-compressed pixel data group; receiving a second input bitstream from a second camera port of the camera interface, and un-packing the second input bitstream into a second compressed pixel data group; de-compressing the second compressed pixel data group to generate a second de-compressed pixel data group; and smoothing at least a pixel boundary between the first de-compressed pixel data group and the second de-compressed pixel data group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data processing system according to an embodiment of the present invention.

FIG. 2 is a diagram of a camera module shown in FIG. 1 according to an embodiment of the present invention.

FIG. 3 is a diagram of one of image signal processors shown in FIG. 1 according to an embodiment of the present invention.

FIG. 4 is a diagram illustrating a rate control mechanism according to an embodiment of the present invention.

FIG. 5 is a diagram illustrating a position-aware rate control mechanism according to an embodiment of the present invention.

FIG. 6 is a flowchart illustrating a control and data flow of the data processing system shown in FIG. 1 according to an embodiment of the present invention.

FIG. 7 is a diagram illustrating a modified compression mechanism according to an embodiment of the present invention.

FIG. 8 is a flowchart illustrating another control and data flow of the data processing system shown in FIG. 1 according to an embodiment of the present invention.

FIG. 9 is a diagram illustrating a pixel data splitting operation performed by a mapper based on another pixel data grouping design.

FIG. 10 is a flowchart illustrating yet another control and data flow of the data processing system shown in FIG. 1 according to an embodiment of the present invention.

FIG. 11 is a block diagram illustrating another data processing system according to an embodiment of the present invention.

FIG. 12 is a diagram illustrating one of image signal processors shown in FIG. 11 according to an embodiment of the present invention.

### DETAILED DESCRIPTION OF THE INVENTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes applying data compression to a multimedia data and then transmitting a compressed multimedia data over a camera interface. As the data size/data rate of the compressed multimedia data is smaller than that of the original un-compressed multimedia data, the power consumption of the camera interface is reduced correspondingly. When the camera interface is required to use a plurality of camera ports for compressed data transmission, the pixel data of one picture may be split into a plurality of pixel data groups, the pixel data groups may be compressed into a plurality of compressed pixel data groups, and the compressed pixel data groups may be transmitted via the camera ports, respectively. The present invention further proposes an image quality improvement scheme which is capable of making a reconstructed picture have better image quality on each pixel boundary between de-compressed pixel data groups. For example, the image quality improvement scheme may employ position-aware rate control, overlapped data compression, and/or position-aware de-blocking. Further details of the image quality improvement scheme will be described as below.

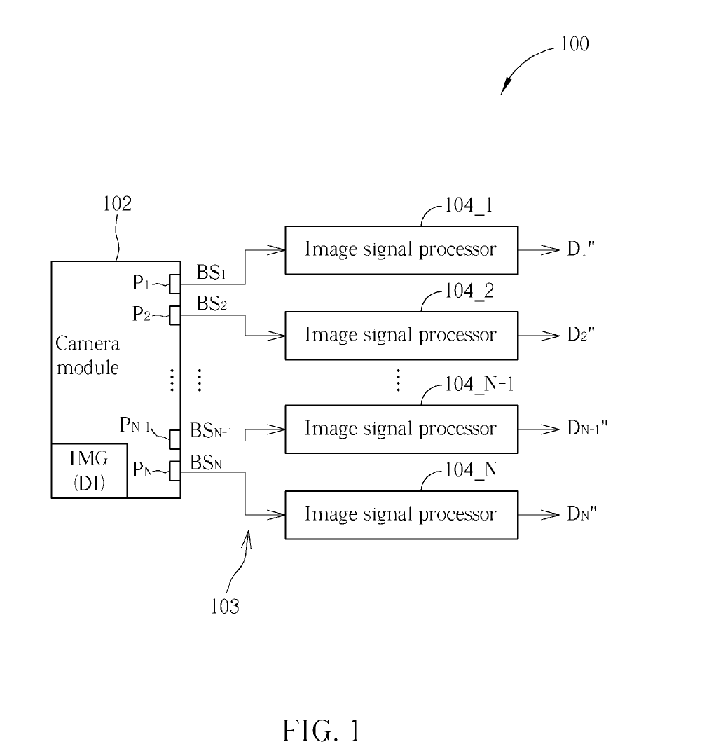

FIG. 1 is a block diagram illustrating a data processing system according to an embodiment of the present invention. The data processing system 100 includes a plurality of data processing apparatuses such as one camera module 102 and a plurality of image signal processors 104_1, 104_2 . . . 104_N−1, 104_N. The number of image signal processors 104_1-104_N depends on the actual camera resolution of the camera module 100. To alleviate the bandwidth requirement between the camera module and the image signal processor, the image signal processors 104_1-104_N are used to process different image partitions of one picture in a parallel manner. In other words, each of the image signal processors 104_1-104_N is responsible for only processing a portion of one picture captured by the camera module 102, and therefore does not need to process all multimedia data of one complete picture.

The camera module 102 and the image signal processors 104_1-104_N may be implemented in different chips. For example, one chip may include the camera module 102, and another chip may include the image signal processors 104_1-104_N. The camera module 102 may communicate with the image signal processors 104_1-104_N via a camera interface 103. In this embodiment, the camera interface 103 may be a camera serial interface (CSI) standardized by a Mobile Industry Processor Interface (MIPI).

To achieve compressed data transmission over the camera interface 103, the camera module 102 supports data compression, and the image signal processors 104_1-104_N support data de-compression. Specifically, the camera module 102 captures one picture IMG and generates a compressed multimedia data by compressing an input multimedia data derived from the picture IMG where the picture IMG may be a single still image or may be one of successive images of a video sequence. In other words, the input multimedia data may be image data or video data that includes pixel data DI of a plurality of pixels of one picture IMG captured by the camera module 102. The camera module 102 obtains the compressed pixel data by compressing the pixel data DI of the picture IMG and outputs different parts of the compressed pixel data through a plurality of camera ports P₁-P_{N} of the camera interface 103, such that the image signal processors 104_1-104_N receive bitstreams BS₁-BS_{N} transmitted from the camera ports P₁-P_{N}, respectively.

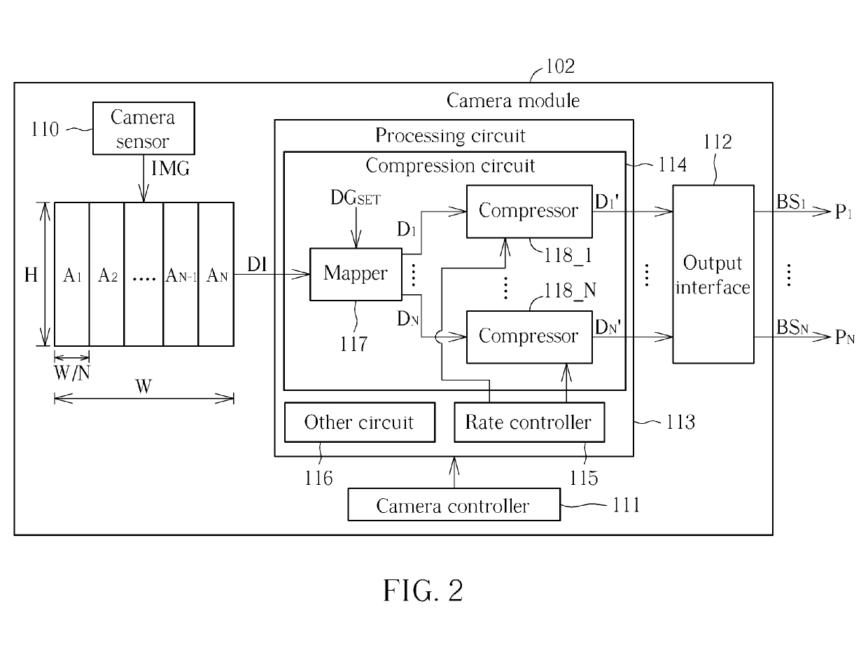

Please refer to FIG. 2, which is a diagram of the camera module 102 shown in FIG. 1 according to an embodiment of the present invention. The camera module 102 includes a camera sensor 110, a camera controller 111, an output interface 112 and a processing circuit 113. The camera sensor 110 is used to obtain an input multimedia data, including pixel data DI of a plurality of pixels of one picture IMG As pixel data DI of the picture IMG is generated from the camera sensor 110, the pixel data format of each pixel depends on the design of the camera sensor 110. For example, when the camera sensor 110 employs a Bayer pattern color filter array (CFA) and performs demosaicing in RGB color space, each pixel may include one blue color component (B), one green color component (G), and one red color component (R). For another example, when the camera sensor 110 employs a Bayer pattern CFA and performs demosaicing in YUV color space, each pixel may include one luminance component (Y) and two chrominance components (U, V). It should be noted that this is for illustrative purposes only, and is not meant to be a limitation of the present invention. A skilled person should readily appreciate that the proposed image quality improvement technique of the present invention can be applied to pixel data DI in any pixel data format supported by the camera sensor 110.

The processing circuit 113 includes circuit elements required for processing the pixel data DI of the picture IMG to generate a plurality of compressed pixel data groups D₁′-D_{N}′. For example, the processing circuit 113 has a compression circuit 114, a rate controller 115, and other circuitry 116. The other circuitry 116 may have a camera buffer, multiplexer(s), etc. In one exemplary design, the camera buffer may be used to buffer the pixel data DI, and output the buffered pixel data DI to the compression circuit 114 through a multiplexer. In another exemplary design, the pixel data DI may bypass the camera buffer and be fed into the compression circuit 114 through the multiplexer. In other words, the pixel data DI to be processed by the compression circuit 114 may be directly provided from the camera sensor 110 or indirectly provided from the camera sensor 110 through the camera buffer.

In this embodiment, the compression circuit 114 includes a mapper 114 and a plurality of compressors 118_1-118_N. The mapper 114 acts as a splitter, and is configured to receive the pixel data DI of one picture IMG and split the pixel data DI of one picture IMG into a plurality of pixel data groups D₁-D_{N} according to a pixel data group setting DG_{SET}. The camera controller 111 is configured to control the operation of the processing circuit 113. As can be seen from FIG. 1, there are N image signal processors 104_1-104_N coupled to the same camera module 102. As shown in FIG. 2, the width of the picture IMG is W, and the height of the picture IMG is H. Supposing that the image signal processors 104_1-104_N have the same computing power, the image partitions A₁-A_{N} may be set by the same size. Hence, each of the image partitions A₁-A_{N} has the same resolution of (W/N)×H. It should be noted that this is for illustrative purposes only. In an alternative design, the image signal processors 104_1-104_N may have different computing power, and the image partitions A₁-A_{N} may be set by different sizes (i.e., different resolutions). Moreover, horizontal image partitioning applied to the picture IMG is not meant to be a limitation of the present invention. In an alternative design, vertical image partitioning may be applied to the picture IMG, thus resulting in multiple image partitions arranged vertically in the picture IMG.

Since there are N image signal processors 104_1-104_N coupled to the camera module 102, N image partitions will be used to generate the compressed pixel data groups to the image signal processors 104_1-104_N, respectively. The pixel data grouping setting DG_{SET} corresponding to the exemplary arrangement of the image partitions A₁-A_{N} shown in FIG. 1 may be decided by the camera controller 111. In an exemplary pixel data grouping design, the pixel data grouping setting DG_{SET} defines selection of non-overlapped pixels for generating each pixel data group. Hence, any pixel included in one pixel group is excluded from other pixel groups. For example, based on the pixel data grouping setting DG_{SET}, the mapper 117 regards all pixels belonging to one image partition as one pixel data group, and only gathers pixel data of the pixel group as one pixel data group. Hence, the pixel data group D₁ only includes pixel data of one pixel group including all pixels belonging to the image partition A₁, and the pixel data group D_{N} only includes pixel data of another pixel group including all pixels belonging to the image partition A_{N}.

The compressors 118_1-118_N are configured to compress the pixel data groups D₁-D_{N} to generate compressed pixel data groups D₁′-D_{N}′, respectively. The rate controller 115 is configured to apply bit rate control to each of the compressors 118_1-118_N for controlling a bit budget allocation per compression unit. In this way, each of the compressed pixel data groups D₁′-D_{N}′ is generated at a desired bit rate. In this embodiment, compression operations performed by the compressors 118_1-118_N are independent of each other, thus enabling rate control with data parallelism. The output interface 112 is configured to refer to the transmission protocol of the camera interface 103 to pack/packetize the compressed pixel data groups D₁′-D_{N}′ into a plurality of output bitstreams BS₁-BS_{N}, respectively; and transmit the output bitstreams BS₁-BS_{N} to the image signal processors 104_1-104_N via the camera ports P₁-P_{N} of the camera interface 103, respectively.

When the camera module 102 transmits one partial compressed multimedia data (e.g., one of compressed pixel data groups D₁′-D_{N}′) to one image signal processor, the image signal processor receives the partial compressed multimedia data from one camera port of the camera interface 103, and de-compresses the partial compressed multimedia data to generate one partial de-compressed multimedia data (e.g., one of de-compressed pixel data groups D₁″-D_{N}″). Each of the image signal processors 104_1-104_N communicates with the camera module 102 via the camera interface 103, and may have the same circuit configuration. For clarity and simplicity, only one of the image signal processors 104_1-104_N is detailed as below.

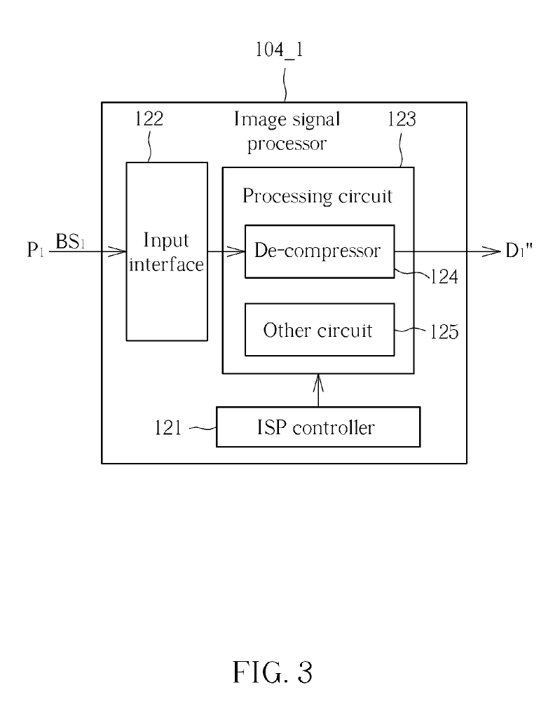

Please refer to FIG. 3, which is a diagram illustrating the image signal processor 104_1 shown in FIG. 1 according to an embodiment of the present invention. The image signal processor 104_1 is coupled to the camera port P₁ of the camera interface 103, and supports compressed data reception. In this embodiment, the image signal processor 104_1 includes an ISP controller 121, an input interface 122 and a processing circuit 123. The input interface 122 is configured to receive an input bitstream (i.e., the bitstream BS₁ transmitted via camera port P₁), and un-pack/un-packetize the input bitstream into a compressed pixel data group of one picture (e.g., compressed pixel data group D₁′ packed in the bitstream BS₁). It should be noted that, if there is no error introduced during the data transmission, the compressed pixel data group un-packed/un-packetized from the input interface 122 should be identical to the compressed pixel data group D₁′ received by the output interface 112.

The ISP controller 121 is configured to control the operation of the processing circuit 123. The processing circuit 123 may include circuit elements required for deriving reconstructed multimedia data from the compressed multimedia data, and may further include other circuit element(s) used for applying additional processing to the reconstructed multimedia data. For example, the processing circuit 123 has a de-compressor 124 and other circuitry 125. The other circuitry 125 may have direct memory access (DMA) controllers, multiplexers, an image processor, etc. When the pixel data grouping design mentioned above is employed by the camera module 102, the de-compressor 124 directly obtains the de-compressed pixel data group D₁″ by de-compressing the compressed pixel data group un-packed/un-packetized from the input interface 122.

The pixel data splitting operation performed by the mapper 117 shown in FIG. 2 is to generate multiple pixel data groups that will undergo rate-controlled compression independently for compressed data transmission over multiple camera ports P₁-P_{N} of the camera interface 103. However, it is possible that pixel data of adjacent pixel lines (e.g., pixel rows or pixel columns) in the original picture are categorized into different pixel data groups. The rate control generally optimizes the bit rate in terms of pixel context rather than pixel positions. The pixel boundary may introduce artifacts since the rate control is not aware of the boundary position.

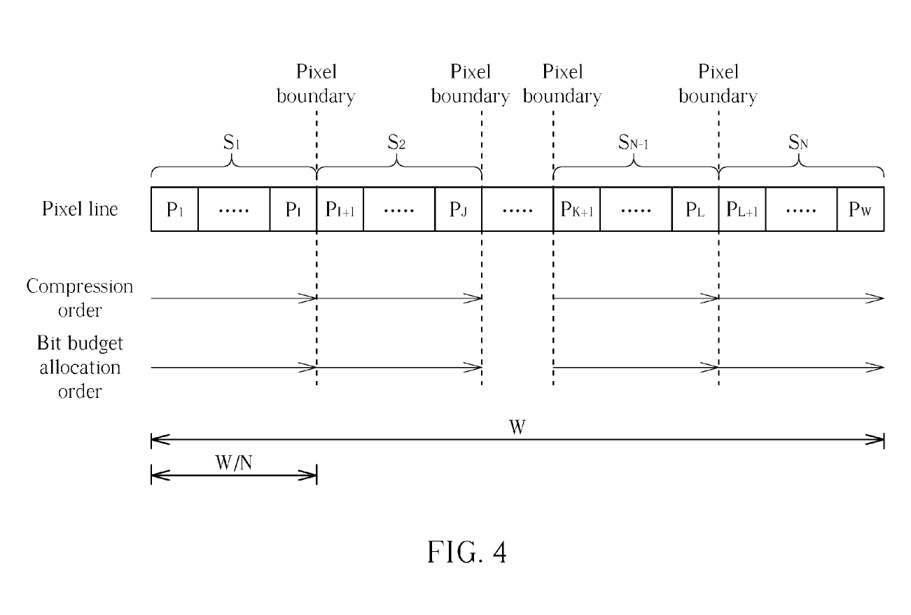

Consider a case where the pixel data grouping setting DG_{SET} defines selection of non-overlapped pixels for generating each pixel data group. Thus, the mapper 117 gathers pixel data of all pixels belonging to one image partition as one pixel data group only. The rate control applied to the pixel data group of the image partition A₁ is independent of the rate control applied to the pixel data group of the image partition A₂, and the rate control applied to the pixel data group of the image partition A_{N-1} is independent of the rate control applied to the pixel data group of the image partition A_{N}. Please refer to FIG. 4, which is a diagram illustrating a rate control mechanism according to an embodiment of the present invention. Based on the pixel data grouping setting DG_{SET}, the mapper 117 splits one pixel line (e.g., one pixel row in this example shown in FIG. 4) composed of pixels P₁-P_{W} into a plurality of pixel sections S₁-S_{N} each having multiple pixels. The pixel sections S₁-S_{N} correspond to the image partitions A₁-A_{N}, respectively. The pixel section S₁ is compressed in an order from P₁ to P_{I}, where I=W/N; the pixel section S₂ is compressed in an order from P_{I+1} to P_{J}, where J=2×(W/N); the pixel section S_{N-1} is compressed in an order from P_{K+1} to P_{L}, where K=(N−2)×(W/N) and L=(N−1)×(W/N); and the pixel section S_{N} is compressed in an order from P_{L+1} to P_{W}. Concerning the pixels P_{I} and P_{I+1} on opposite sides of a pixel boundary between pixel sections S₁ and S₂, the pixel P_{I} may be part of a compression unit with one bit budget allocation, and the pixel P_{I+1} may be part of another compression unit with a different bit budget allocation. Similarly, concerning the pixels P_{L} and P_{L+1} on opposite sides of a pixel boundary between pixel sections S_{N-1} and S_{N}, the pixel P_{L} may be part of a compression unit with one bit budget allocation, and the pixel P_{L+1} may be part of another compression unit with a different bit budget allocation. The difference between the bit budget allocations of compression units on opposite of a pixel boundary may be large. As a result, the rate controller 115 may allocate bit rates un-evenly on the pixel boundary, thus resulting in degraded image quality on the pixel boundary in a reconstructed picture. To avoid or mitigate the image quality degradation caused by artifacts on the pixel boundary, the present invention therefore proposes using a position-aware rate control mechanism which optimizes the bit budget allocation in terms of pixel positions.

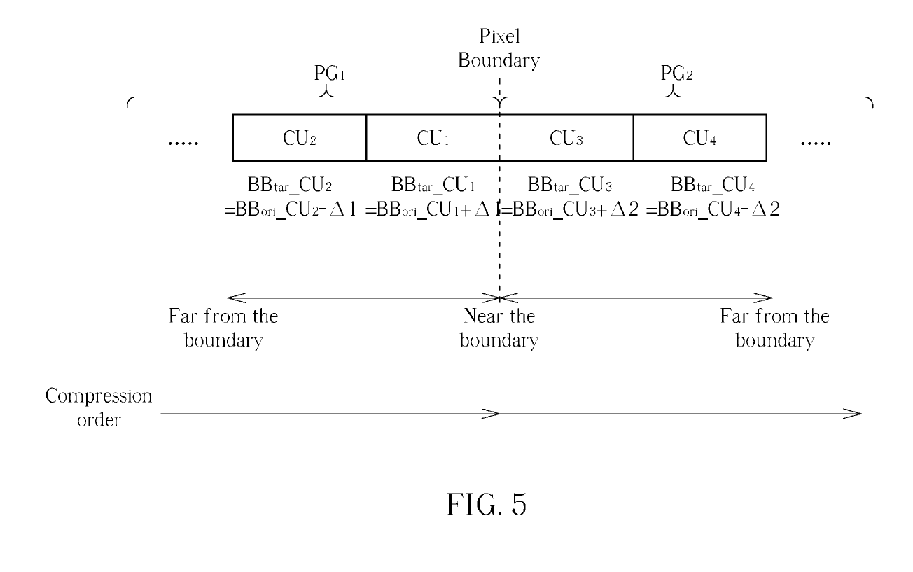

FIG. 5 is a diagram illustrating a position-aware rate control mechanism according to an embodiment of the present invention. As shown in FIG. 5, there are compression units CU₁ and CU₂ on one side of a pixel boundary and compression units CU₃ and CU₄ on the other side of the pixel boundary. The compression units CU₁ and CU₂ belong to one pixel group PG₁, and the compression unit CU₁ is nearer to the pixel boundary than the compression unit CU₂. The compression units CU₃ and CU₄ belong to another pixel group PG₂, and the compression unit CU₃ is nearer to the pixel boundary than the compression unit CU₄. For example, the pixel group PG₁ may be compressed into one compressed pixel data group D₁′ (or D_{N-1}′), and the pixel group PG₂ may be compressed into another compressed pixel data group D₂′ (or D_{N}′). In one exemplary embodiment, each of the compression units CU₁-CU₄ may include X×Y pixels, and the compression units CU₁-CU₄ may be horizontally or vertically adjacent in one picture. For example, X may be 4 and Y may be 2. When the position-aware rate control mechanism is activated, the camera controller 111 may give pixel position information to the rate controller 115, and the rate controller 115 may adjust the bit-rate control (i.e., bit budget allocation) according to a position of each pixel boundary between different pixel groups. For example, the rate controller 115 increases an original bit budget BBori_CU₁ assigned to the compression unit CU₁ by an adjustment value Δ1 (Δ1>0) to thereby determine a final bit budget BBtar_CU₁, and decreases an original bit budget BBori_CU₂ assigned to the compression unit CU₂ by the adjustment value Δ1 to thereby determine a final bit budget BBtar_CU₂. In addition, the rate controller 115 increases an original bit budget BBori_CU₃ assigned to the compression unit CU₃ by an adjustment value Δ2 (Δ2>0) to thereby determine a final bit budget BBtar_CU₃, and decreases an original bit budget BBori_CU₄ assigned to the compression unit CU₄ by the adjustment value Δ2 to thereby determine a final bit budget BBtar_CU₄. The adjustment value Δ2 may be equal to or different from the adjustment value Δ1, depending upon actual design consideration. Since the proposed position-aware rate control tends to set a larger bit budget near the pixel boundary, the artifacts on the pixel boundary can be reduced. In this way, the image quality around the pixel boundary in a reconstructed picture can be improved.

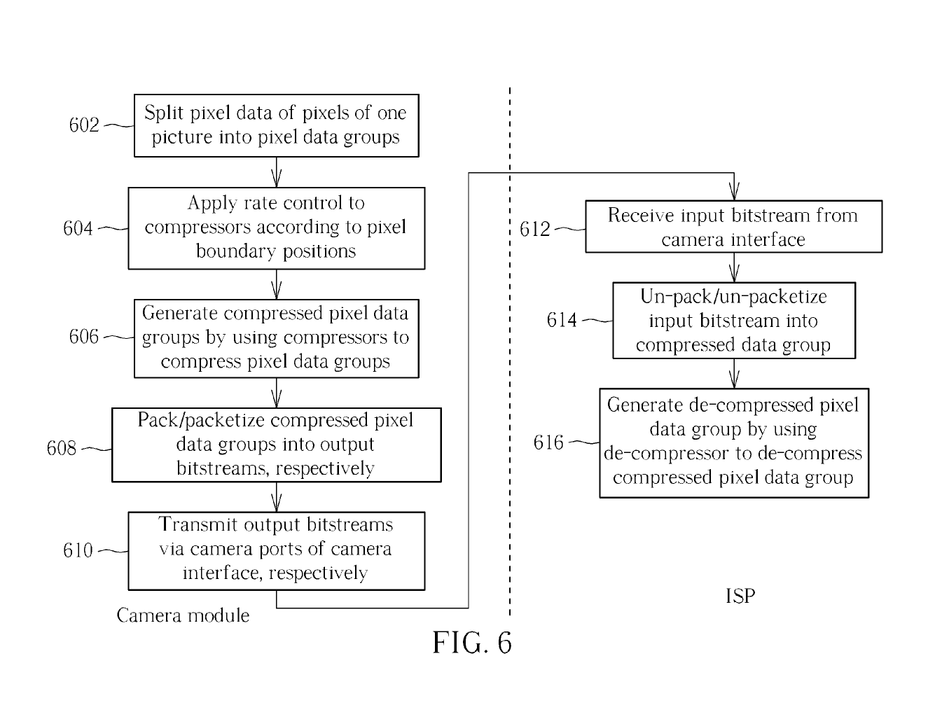

FIG. 6 is a flowchart illustrating a control and data flow of the data processing system shown in FIG. 1 according to an embodiment of the present invention. Provided that the result is substantially the same, the steps are not required to be executed in the exact order shown in FIG. 6. The exemplary control and data flow may be briefly summarized by following steps.

Step 602: Split pixel data of a plurality of pixels of one picture into a plurality of pixel data groups.

Step 604: Apply rate control to each of a plurality of compressors according to pixel boundary positions.

Step 606: Generate a plurality of compressed pixel data groups by using the compressors to compress the pixel data groups, respectively.

Step 608: Pack/packetize the compressed pixel data groups into a plurality of output bitstreams, respectively.

Step 610: Transmit the output bitstreams via a plurality of camera ports of a camera interface, respectively.

Step 612: Receive an input bitstream from the camera interface.

Step 614: Un-pack/un-packetize the input bitstream into a compressed data group.

Step 616: Generate a de-compressed pixel data group by using a de-compressor to de-compress the compressed pixel data group.

It should be noted that steps 602-610 are performed by the camera module 102, and steps 612-616 are performed by one of the image signal processors 104_1-104_N. As a person skilled in the art can readily understand details of each step shown in FIG. 6 after reading above paragraphs, further description is omitted here for brevity.

As can be seen from FIG. 4, the rate control applied to the pixel section S₁ of a pixel line (e.g., pixel row or pixel column) is independent of the rate control applied to the pixel section S₂ of the same pixel line. The pixel section S₁ is compressed in an order from P₁ to P_{I}, and the pixel section S₂ is compressed in an order from P_{I+1} to P_{J}. The pixel section S_{N-1} is compressed in an order from P_{K+1} to P_{L}, and the pixel section S_{N} is compressed in an order from P_{L+1} to P_{W}. In other words, each pixel section located at the same pixel line is compressed in the same compression order, as shown in FIG. 4. As a result, the bit budget allocation condition for the pixel P_{I} (which is the last compressed pixel in the pixel section S₁) may be different from the bit budget allocation condition for the pixel P_{I+1} (which is the first compressed pixel in the pixel section S₂); and the bit budget allocation condition for the pixel P_{L} (which is the last compressed pixel in the pixel section S_{N-1}) may be different from the bit budget allocation condition for the pixel P_{L+1} (which is the first compressed pixel in the pixel section S_{N}). To avoid or reduce artifacts on the pixel boundary, the present invention further proposes a modified compression mechanism with compression orders set based on pixel boundary positions.

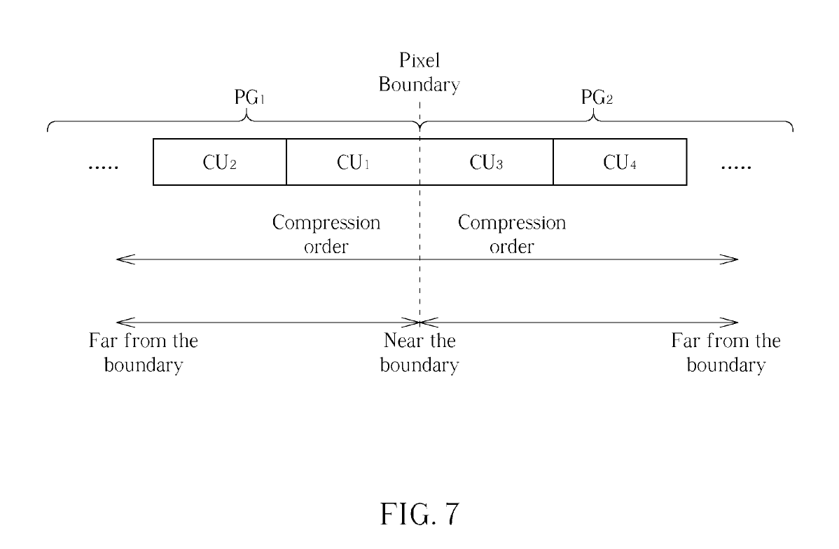

Please refer to FIG. 7, which is a diagram illustrating a modified compression mechanism according to an embodiment of the present invention. As shown in FIG. 7, there are compression units CU₁ and CU₂ on one side of a pixel boundary and compression units CU₃ and CU₄ on the other side of the pixel boundary. The compression units CU₁ and CU₂ belong to one pixel group PG₁, and the compression unit CU₁ is nearer to the pixel boundary than the compression unit CU₂. The compression units CU₃ and CU₄ belong to another pixel group PG₂, and the compression unit CU₃ is nearer to the pixel boundary than the compression unit CU₄. For example, the pixel group PG₁ may be compressed into one compressed pixel data group D₁′ (or D_{N-1}′), and the pixel group PG₂ may be compressed into another compressed pixel data group D₂′ (or D_{N}′).

In one exemplary embodiment, each of the compression units CU₁-CU₄ may include X×Y pixels, and the compression units CU₁-CU₄ may be horizontally or vertically adjacent in a picture. For example, X may be 4 and Y may be 2. When the modified compression mechanism is activated, the camera controller 111 may give pixel position information to the compressors 118_1-118_N, and each of the compressors 115_1 and 115_2 may set a compression order according to a position of each pixel boundary between different pixel groups. For example, the compressor 118_1 compresses the compression unit CU₁ prior to compressing the compression unit CU₂, and the compressor 118_2 compresses the compression unit CU₃ prior to compressing the compression unit CU₄. In other words, two adjacent pixel sections located at the same pixel line are compressed in opposite compression orders. Since the modified compression scheme starts the compression from compression units near the pixel boundary between adjacent pixel groups, the bit budget allocation conditions near the pixel boundary may be more similar. In this way, the image quality around the pixel boundary in a reconstructed picture can be improved.

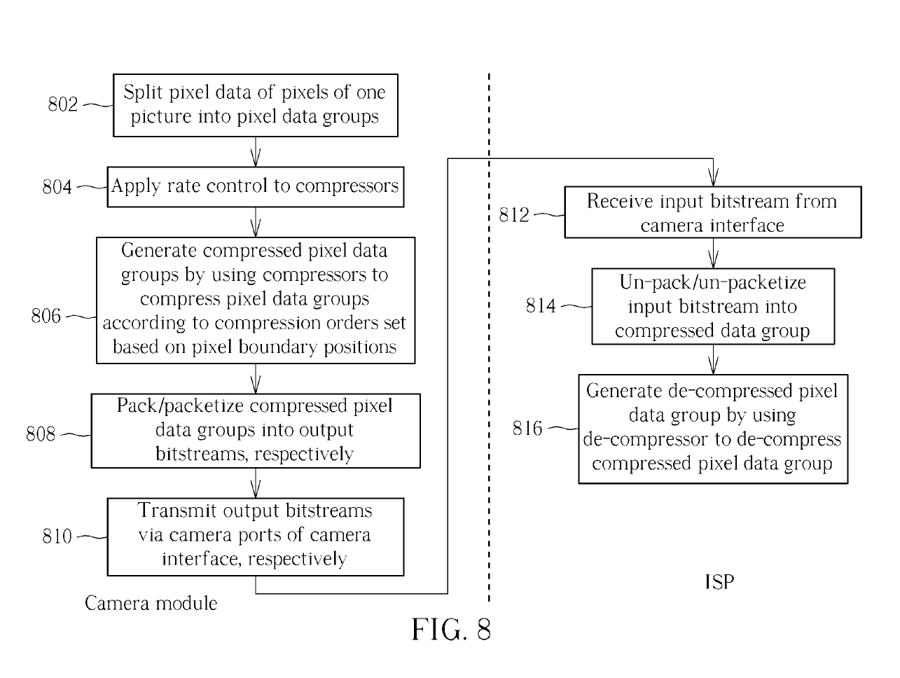

FIG. 8 is a flowchart illustrating another control and data flow of the data processing system shown in FIG. 1 according to an embodiment of the present invention. Provided that the result is substantially the same, the steps are not required to be executed in the exact order shown in FIG. 8. The exemplary control and data flow may be briefly summarized by following steps.

Step 802: Split pixel data of a plurality of pixels of one picture into a plurality of pixel data groups.

Step 804: Apply rate control to each of a plurality of compressors.

Step 806: Generate a plurality of compressed pixel data groups by using the compressors to compress the pixel data groups according to compression orders set based on pixel boundary positions.

Step 808: Pack/packetize the compressed pixel data groups into a plurality of output bitstreams, respectively.

Step 810: Transmit the output bitstreams via a plurality of camera ports of a camera interface, respectively.

Step 812: Receive an input bitstream from the camera interface.

Step 814: Un-pack/un-packetize the input bitstream into a compressed data group.

Step 816: Generate a de-compressed pixel data group by using a de-compressor to de-compress the compressed pixel data group.

It should be noted that steps 802-810 are performed by the camera module 102, and steps 812-816 are performed by one of the image signal processors 104_1-104_N. As a person skilled in the art can readily understand details of each step shown in FIG. 8 after reading above paragraphs, further description is omitted here for brevity.

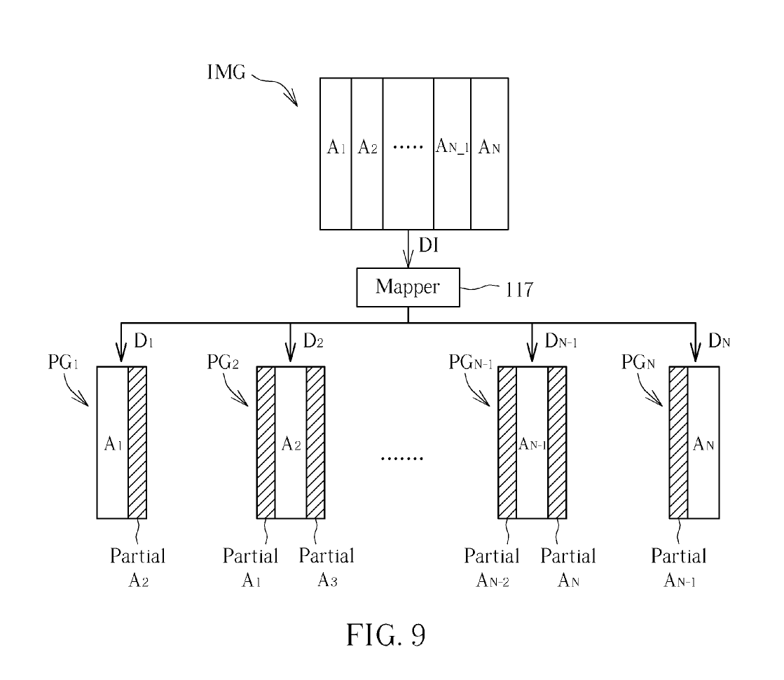

In above embodiments, the pixel data grouping setting DG_{SET} defines selection of non-overlapped pixels for generating each pixel data group. In another pixel data grouping design, the pixel data grouping setting DG_{SET} may define selection of overlapped pixels for generating each pixel data group. Hence, some pixels included in one pixel group are also included in another pixel group. Please refer to FIG. 9, which is a diagram illustrating a pixel data splitting operation performed by a mapper based on another pixel data grouping design. In this embodiment, based on the pixel data grouping setting DG_{SET} that supports selection of overlapped pixels, the mapper 117 gathers pixel data of a pixel group as one pixel data group, where the pixel group includes all pixels belonging to one image partition and some pixels belonging to adjacent image partition(s). Hence, as shown in FIG. 9, the pixel data group D₁ is composed of pixel data of a pixel group PG₁ including all pixels belonging to the image partition A₁ and pixel data of some pixels belonging to one adjacent image partition A₂; the pixel data group D₂ is composed of pixel data of a pixel group PG₂ including all pixels belonging to the image partition A₂ and pixel data of some pixels belonging to two adjacent image partitions A₁ and A₃; the pixel data group D_{N-1} is composed of pixel data of a pixel group PG_{N-1} including all pixels belonging to the image partition A_{N-1} and pixel data of some pixels belonging to two adjacent image partitions A_{N-1} and A_{N}; and the pixel data group D_{N} is composed of pixel data of a pixel group PG_{N} including all pixels belonging to the image partition A_{N} and pixel data of some pixels belonging to one adjacent image partition A_{N-1}.

As can be seen in FIG. 9, two adjacent pixel groups have overlapped pixels, where the number of overlapped pixels may be programmable. In addition, concerning each of the pixel groups, the pixel group includes pixels inside an image partition to be actually output from an image signal processor, and further includes pixels outside the image partition to be actually output from the image signal processor. For example, the pixel group PG₁ includes pixels of a portion of the image partition A₂ that will not be actually output from the image signal processor 104_1, the pixel group PG₂ includes pixels of a portion of the image partition A₁ and pixels of a portion of the image partition A₃ that will not be actually output from the image signal processor 104_2, the pixel group PG_{N-1} includes pixels of a portion of the image partition A_{N-2} and pixels of a portion of the image partition A_{N} that will not be actually output from the image signal processor 104_N−1, and the pixel group PG_{N} includes pixels of a portion of the image partition A_{N-1} that will not be actually output from the image signal processor 104_N.

The compressors 118_1-118_N compress the pixel data groups D₁-D_{N} corresponding to the pixel groups PG₁-PG_{N} having overlapped pixels, and accordingly generate the compressed pixel data groups D₁′-D_{N}′. In this embodiment, each of the pixel data groups D₁-D_{N} is compressed in the same compression order (e.g., an order from a left-most pixel in a pixel section of a pixel line to a right-most pixel in the same pixel section). The desired pixels (i.e., pixels needed to be actually output from one image signal processor) in the pixel group are on one side of a pixel boundary, and additional pixels (i.e., overlapped pixels) in the pixel group are on the other side of the pixel boundary. Hence, the bit rate control applied to compression of the pixel group may borrow the bit budget from the overlapped pixels to assign a larger bit budget to desired pixels near the pixel boundary. In this way, when reconstructed image partitions are displayed on a display screen, the artifacts on the pixel boundaries can be reduced.

When the aforementioned pixel data grouping design that supports selection of overlapped pixels is employed by the camera module 102, the de-compressor 124 shown in FIG. 3 is configured to obtain a preliminary de-compressed pixel data group corresponding to a partial image area (e.g., complete A₁+partial A₂) of the picture IMG by de-compressing the compressed pixel data group un-packed from the input interface 122, and discards a portion of the preliminary de-compressed pixel data group that corresponds to pixels beyond a target image area (e.g., A₁) of the partial image area to generate the de-compressed pixel data group (e.g., D₁″).

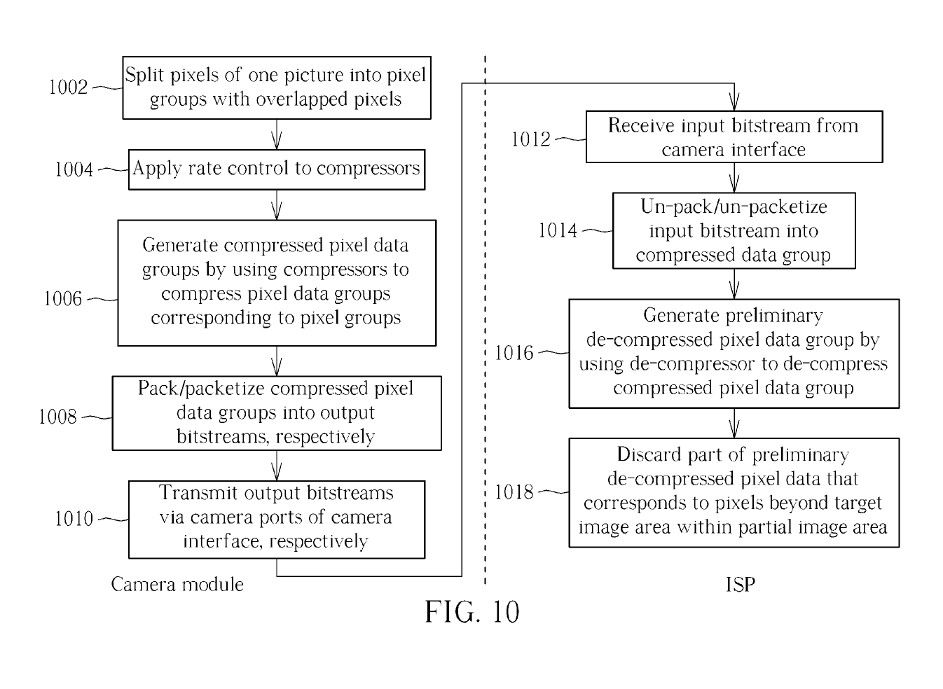

FIG. 10 is a flowchart illustrating yet another control and data flow of the data processing system shown in FIG. 1 according to an embodiment of the present invention. Provided that the result is substantially the same, the steps are not required to be executed in the exact order shown in FIG. 10. The exemplary control and data flow may be briefly summarized by following steps.

Step 1002: Split a plurality of pixels of one picture into a plurality of pixel groups with overlapped pixels.

Step 1004: Apply rate control to each of a plurality of compressors.

Step 1006: Generate a plurality of compressed pixel data groups by using the compressors to compress a plurality of pixel data groups corresponding to the pixel groups.

Step 1008: Pack/packetize the compressed pixel data groups into a plurality of output bitstreams, respectively.

Step 1010: Transmit the output bitstreams via a plurality of camera ports of a camera interface, respectively.

Step 1012: Receive an input bitstream from the camera interface.

Step 1014: Un-pack/un-packetize the input bitstream into a compressed data group that corresponds to pixels in a partial image area of the picture.

Step 1016: Generate a preliminary de-compressed pixel data group by using a de-compressor to de-compress the compressed pixel data group.

Step 1018: Discard a portion of the preliminary de-compressed pixel data that corresponds to pixels beyond a target image area within the partial image area.

It should be noted that steps 1002-1010 are performed by the camera module 102, and steps 1012-1018 are performed by one of the image signal processors 104_1-104_N. As a person skilled in the art can readily understand details of each step shown in FIG. 10 after reading above paragraphs, further description is omitted here for brevity.

In above embodiments, position-aware rate control and/or overlapped data compression may be employed to mitigate or avoid artifacts on pixel boundaries. The present invention further proposes an image quality improvement scheme which may use a post-processing means (e.g., de-blocking) to mitigate or avoid artifacts on pixel boundaries.

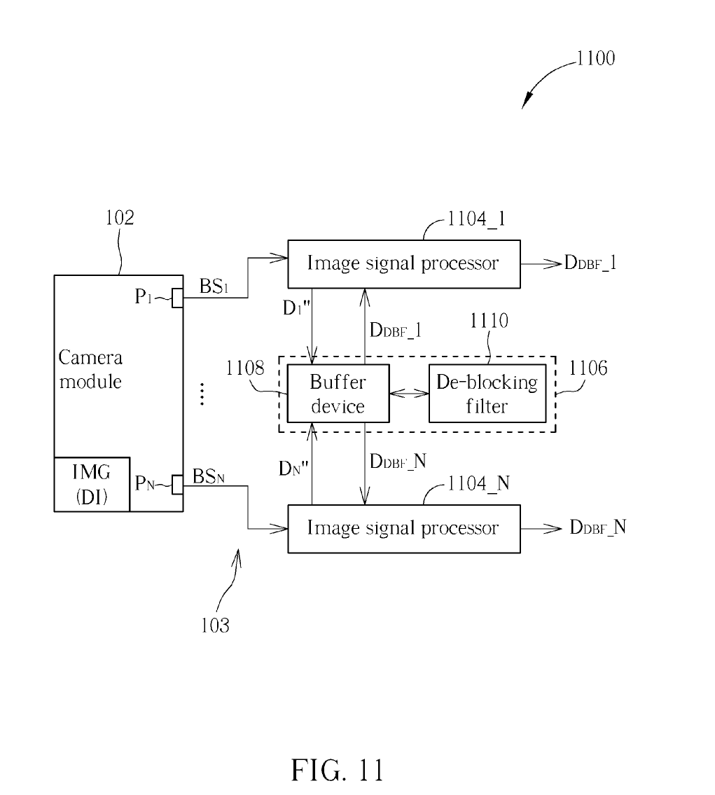

FIG. 11 is a block diagram illustrating another data processing system according to an embodiment of the present invention. The data processing system 1100 includes a plurality of data processing apparatuses such as a plurality of image signal processors 1104_1-1104_N, a post-processing circuit 1106, and the aforementioned camera module 102. The difference between data processing systems 100 and 1100 is that the image signal processors 1104_1-1104_N transmit the de-compressed pixel data groups D₁″-D_{N}″ to the post-processing circuit 1106. The de-compressed pixel data groups D₁″-D_{N}″ correspond to different image partitions of one reconstructed image that will be displayed on a display screen under the control of a plurality of driver integrated circuits (driver ICs) coupled to the image signal processors 1104_1-1104_N. In this embodiment, the post-processing circuit 1106 is configured to smooth pixel boundaries of the de-compressed pixel data groups D₁″-D_{N}″ for mitigating/avoiding artifacts on the pixel boundaries. As shown in FIG. 11, the post-processing circuit 1106 includes a buffer device 1108 and a de-blocking filter 1110. The buffer device 1108 is configured to buffer the reconstructed image composed of the de-compressed pixel data groups D₁″-D_{N}″. The de-blocking filter 1110 is configured to perform a position-aware de-blocking operation upon the reconstructed image. Hence, the position-aware de-blocking operation is performed based on the de-compressed pixel data groups D₁″-D_{N}″ read from the buffer device 1108. In this way, a reconstructed image with smoothed pixel boundaries is generated from the de-blocking filter 1110 and stored in the buffer device 1108.

It should be noted that each of the image signal processors 1104_1-1104_N is responsible for only processing a portion of one picture captured by the camera module 102. Hence, when the reconstructed image with smoothed pixel boundaries is available in the buffer device 1108, the image signal processors 1104_1-1104_N read de-compressed pixel data groups D_{DBF}_{_}1-l D_{DBF}_{_}N (i.e., de-blocking filtering results of the de-compressed pixel data groups D₁″-D_{N}″) from the buffer device 1108, respectively. Each of the image signal processors 1104_1-1104_N communicates with the camera module 102 via the camera interface 103, and may have the same circuit configuration. For clarity and simplicity, only one of the image signal processors 1104_1-1104_N is detailed as below.

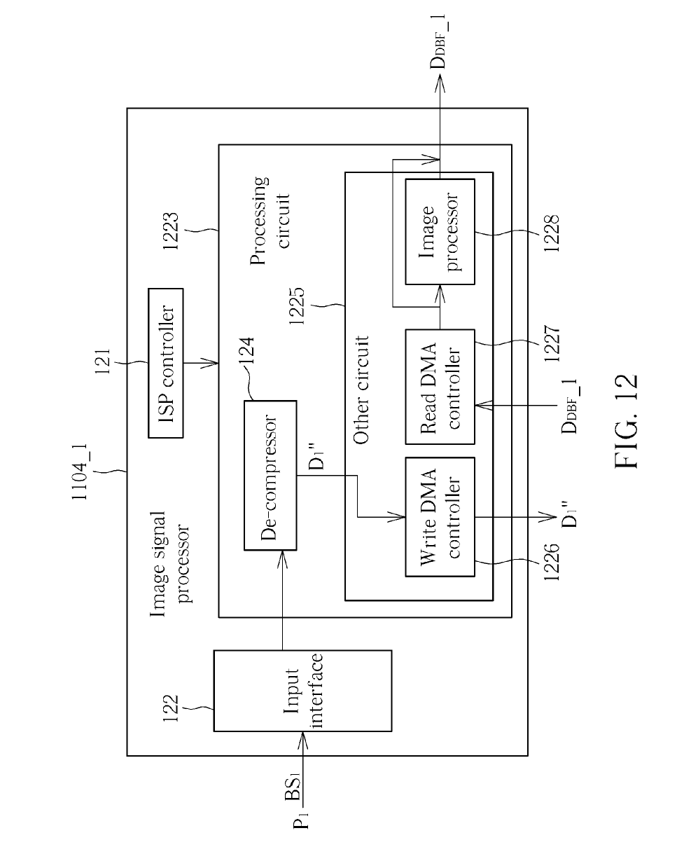

Please refer to FIG. 12, which is a diagram illustrating the image signal processor 1104_1 shown in FIG. 11 according to an embodiment of the present invention. The image signal processor 1104_1 is coupled to the camera port P₁ of the camera interface 103, and supports compressed data reception. In this embodiment, the image signal processor 1104_1 includes the aforementioned input interface 122 and ISP controller 121, and further includes a processing circuit 1223. The processing circuit 1223 includes the aforementioned de-compressor 124, and further includes other circuitry 1225. As a person skilled in the art can readily understand functions and operations of interface 122, ISP controller 121, and de-compressor 124 after reading above paragraphs, further description is omitted here for brevity.

In this embodiment, the other circuitry 1225 may have a write DMA controller 1226, a read DMA controller 1227, an image processor 1228, etc. The buffer device 1108 shown in FIG. 11 may be a dynamic random access memory (DRAM). The write DMA controller 1226 and the read DMA controller 1227 are coupled to the buffer device 1108 for accessing the buffer device 1108. Hence, the de-compressed pixel data group D₁″ generated from the de-compressor 124 is stored into the buffer device 1108 through the write DMA controller 1226, and the de-compressed pixel data group D_{DBF}_{_}1 (i.e., de-blocking filtering result of de-compressed pixel data groups D₁″) is read from the buffer device 1108 through the buffer device 1108. The de-compressed pixel data group D_{DBF}_{_}1 may be processed by the image processor 1228 before output from the image signal processor 1104_1. Alternatively, the de-compressed pixel data group D_{DBF}_{_}1 may bypass the image processor 1228 and be output from the image signal processor 1104_1.

Those skilled in the art will readily observe that numerous modifications and alterations of the device and method may be made while retaining the teachings of the invention. Accordingly, the above disclosure should be construed as limited only by the metes and bounds of the appended claims.

1. A data processing apparatus, comprising:
a compression circuit, configured to generate a plurality of compressed pixel data groups, each derived from applying a compression operation to pixel data of a pixel group, wherein the pixel group includes a portion of a plurality of pixels in a picture;
a rate controller, configured to apply bit rate control to each compression operation, wherein the rate controller adjusts the bit rate control according to a position of each pixel boundary between different pixel groups; and
an output interface, configured to output the compressed pixel data groups via a plurality of camera ports of a camera interface, respectively.

2. The data processing apparatus of claim 1, wherein the camera interface is a camera serial interface (CSI) standardized by a Mobile Industry Processor Interface (MIPI).

3. The data processing apparatus of claim 1, wherein concerning a specific pixel boundary between a first pixel group and a second pixel group, the rate controller is configured to increase an original bit budget assigned to a first compression unit by an adjustment value and decrease an original bit budget assigned to a second compression unit by the adjustment value; the first compression unit and the second compression unit are adjacent compression units in any of the first pixel group and the second pixel group; and the first compression unit is nearer to the specific pixel boundary than the second compression unit.

4. A data processing apparatus, comprising:
a compression circuit, configured to generate a plurality of compressed pixel data groups, each derived from applying a compression operation to pixel data of a pixel group according to a compression order, wherein the pixel group includes a portion of a plurality of pixels in a picture, and the compression order is set according to a position of a pixel boundary between the pixel group and an adjacent pixel group; and
an output interface, configured to output the compressed pixel data groups via a plurality of camera ports of a camera interface, respectively.

5. The data processing apparatus of claim 4, wherein the camera interface is a camera serial interface (CSI) standardized by a Mobile Industry Processor Interface (MIPI).

6. The data processing apparatus of claim 4, wherein the compression circuit is configured to compress a first compression unit prior to compressing a second compression unit, and compress a third compression unit prior to compressing a fourth compression unit; the first compression unit and the second compression unit are adjacent compression units in the pixel group, and the first compression unit is nearer to the pixel boundary than the second compression unit; and the third compression unit and the fourth second compression unit are adjacent compression units in the adjacent pixel group, and the third compression unit is nearer to the pixel boundary than the fourth compression unit.

7. A data processing apparatus, comprising:
a compression circuit, configured to generate a plurality of compressed pixel data groups, each derived from applying a compression operation to pixel data of a pixel group, wherein the pixel group includes a portion of a plurality of pixels in a picture, and at least two pixel groups have overlapped pixels; and
an output interface, configured to output the compressed pixel data groups via a plurality of camera ports of a camera interface, respectively.

8. The data processing apparatus of claim 7, wherein the camera interface is a camera serial interface (CSI) standardized by a Mobile Industry Processor Interface (MIPI).

9. A data processing apparatus, comprising:
an input interface, configured to receive an input bitstream from a camera port of a camera interface, and un-pack the input bitstream into a compressed pixel data group that corresponds to pixels in a partial image area of a picture; and
a de-compressor, configured to de-compress the compressed pixel data group to generate a de-compressed pixel data group, and discard a portion of the de-compressed pixel data group that corresponds to pixels beyond a target image area within the partial image area.

10. The data processing apparatus of claim 9, wherein the camera interface is a camera serial interface (CSI) standardized by a Mobile Industry Processor Interface (MIPI).

11. A data processing system, comprising:
a first data processing apparatus, comprising:
a first input interface, configured to receive a first input bitstream from a first camera port of a camera interface, and un-pack the first input bitstream into a first compressed pixel data group; and
a first de-compressor, configured to de-compress the first compressed pixel data group to generate a first de-compressed pixel data group;
a second data processing apparatus, comprising:
a second input interface, configured to receive a second input bitstream from a second camera port of the camera interface, and un-pack the second input bitstream into a second compressed pixel data group; and
a second de-compressor, configured to de-compress the second compressed pixel data group to generate a second de-compressed pixel data group; and
a post-processing circuit, configured to smooth at least a pixel boundary between the first de-compressed pixel data group and the second de-compressed pixel data group.

12. The data processing system of claim 11, wherein the post-processing circuit comprises:
a buffer device, configured to buffer the first de-compressed pixel data group and the second de-compressed pixel data group; and
a de-blocking filter, configured to perform a de-blocking operation based on the first de-compressed pixel data group and the second de-compressed pixel data group read from the buffer device.

13. The data processing system of claim 11, wherein the camera interface is a camera serial interface (CSI) standardized by a Mobile Industry Processor Interface (MIPI).

14. A data processing method, comprising:
applying bit rate control to each compression operation, wherein the bit rate control is adjusted according to a position of each pixel boundary between different pixel groups;
generating a plurality of compressed pixel data groups, each derived from applying a compression operation to pixel data of a pixel group, wherein the pixel group includes a portion of a plurality of pixels in a picture; and
outputting the compressed pixel data groups via a plurality of camera ports of a camera interface, respectively.

15. The data processing method of claim 14, wherein the camera interface is a camera serial interface (CSI) standardized by a Mobile Industry Processor Interface (MIPI).

16. The data processing method of claim 14, wherein concerning a specific pixel boundary between a first pixel group and a second pixel group, the bit rate control increases an original bit budget assigned to a first compression unit by an adjustment value and decreases an original bit budget assigned to a second compression unit by the adjustment value; the first compression unit and the second compression unit are adjacent compression units in any of the first pixel group and the second pixel group; and the first compression unit is nearer to the specific pixel boundary than the second compression unit.

17. A data processing method, comprising:
generating a plurality of compressed pixel data groups, each derived from applying a compression operation to pixel data of a pixel group according to a compression order, wherein the pixel group includes a portion of a plurality of pixels in a picture, and the compression order is set according to a position of a pixel boundary between the pixel group and an adjacent pixel group; and
outputting the compressed pixel data groups via a plurality of camera ports of a camera interface, respectively.

18. The data processing method of claim 17, wherein the camera interface is a camera serial interface (CSI) standardized by a Mobile Industry Processor Interface (MIPI).

19. The data processing method of claim 17, wherein the step of generating the compressed pixel data groups comprises:
compressing a first compression unit prior to compressing a second compression unit; and
compressing a third compression unit prior to compressing a fourth compression unit;
wherein the first compression unit and the second compression unit are adjacent compression units in the pixel group, and the first compression unit is nearer to the pixel boundary than the second compression unit; and the third compression unit and the fourth second compression unit are adjacent compression units in the adjacent pixel group, and the third compression unit is nearer to the pixel boundary than the fourth compression unit.

20. A data processing method, comprising:
generating a plurality of compressed pixel data groups, each derived from applying a compression operation to pixel data of a pixel group, wherein the pixel group includes a portion of a plurality of pixels in a picture, and at least two pixel groups have overlapped pixels; and
outputting the compressed pixel data groups via a plurality of camera ports of a camera interface, respectively.

21. The data processing method of claim 20, wherein the camera interface is a camera serial interface (CSI) standardized by a Mobile Industry Processor Interface (MIPI).

22. A data processing method, comprising:
receiving an input bitstream from a camera port of a camera interface, and un-packing the input bitstream into a compressed pixel data group that corresponds to pixels in a partial image area of a picture; and
de-compressing the compressed pixel data group to generate a de-compressed pixel data group, and discarding a portion of the de-compressed pixel data group that corresponds to pixels beyond a target image area within the partial image area.

23. The data processing method of claim 22, wherein the camera interface is a camera serial interface (CSI) standardized by a Mobile Industry Processor Interface (MIPI).

24. A data processing method, comprising:
receiving a first input bitstream from a first camera port of a camera interface, and un-packing the first input bitstream into a first compressed pixel data group;
de-compressing the first compressed pixel data group to generate a first de-compressed pixel data group;
receiving a second input bitstream from a second camera port of the camera interface, and un-packing the second input bitstream into a second compressed pixel data group;
de-compressing the second compressed pixel data group to generate a second de-compressed pixel data group; and
smoothing at least a pixel boundary between the first de-compressed pixel data group and the second de-compressed pixel data group.

25. The data processing method of claim 24, wherein the step of smoothing at least the pixel boundary between the first de-compressed pixel data group and the second de-compressed pixel data group comprises:
buffering the first de-compressed pixel data group and the second de-compressed pixel data group in a buffer device; and
performing a de-blocking operation based on the first de-compressed pixel data group and the second de-compressed pixel data group read from the buffer device.

26. The data processing method of claim 24, wherein the camera interface is a camera serial interface (CSI) standardized by a Mobile Industry Processor Interface (MIPI).
